(19) United States
(12) Patent Application Publication
(10) Pub. No.: US 2013/0073443 A1
(43) Pub. Date: Mar. 21, 2013

(54) METHOD FOR AUTOMATED TRADING BASED ON INFORMATION IN A PRESS RELEASE

(71) Applicants: Lawrence C. Rafsky, Livingston, NJ (US); Stephen W. Leahy, Miami Beach, FL (US); Robert E. Ungar, Randolph, NJ (US); Thomas B. Donchez, Bethlehem, PA (US); Lonne F. Katz, Parsippany, NJ (US); Nigel Thornton Clark, Princeton, NJ (US); Marek Samulka, Hackensack, NJ (US); Zhi X. Chen, Livingston, NJ (US); Mark J. Testa, Spotswood, NJ (US); Christopher W. Lee, Brooklyn, NY (US)

(72) Inventors: Lawrence C. Rafsky, Livingston, NJ (US); Stephen W. Leahy, Miami Beach, FL (US); Robert E. Ungar, Randolph, NJ (US); Thomas B. Donchez, Bethlehem, PA (US); Lonne F. Katz, Parsippany, NJ (US); Nigel Thornton Clark, Princeton, NJ (US); Marek Samulka, Hackensack, NJ (US); Zhi X. Chen, Livingston, NJ (US); Mark J. Testa, Spotswood, NJ (US); Christopher W. Lee, Brooklyn, NY (US)

(21) Appl. No.: 13/622,803

(22) Filed: Sep. 19, 2012

Related U.S. Application Data
(60) Provisional application No. 61/536,288, filed on Sep. 19, 2011.

(51) Int. Cl. G06Q 40/04

(52) U.S. Cl. 705/37

(57) ABSTRACT

A method for automated trading based on information in a press release is disclosed. A programmed computer receives a press release from a wire service. The programmed computer scans each word of the press release sequentially. The programmed computer employs a scanned word as an index into a pre-processed table of reduced-encoded, negative sentiment and positive sentiment words, where sentiment is measured on a log-scale. The programmed computer fetches a word from the table based on the index. The programmed computer renders at least one trading decision based on the fetched word. The programmed computer delivers the at least one trading decision to at least one trading system.

### CROSS-REFERENCE TO RELATED APPLICATION

This application claims the benefit of U.S. provisional patent application No. 61/536,288 filed Sep. 19, 2011, the disclosure of which is incorporated herein by reference in its entirety.

### FIELD OF THE INVENTION

The present invention relates generally to a method and system for processing press releases. More specifically, the present invention relates to a method for automated trading based on information in a press release.

### BACKGROUND OF THE INVENTION

Related art methods for automating news-based trading of corporate securities rely on very fast execution of a pipeline of processing steps. The pipeline of processing steps are applied to text-based press releases issued by publicly-traded corporations (i.e., in compliance with SEC Regulation FD) after transmission by one of several wire services to investment firms and public distribution venues.

Sophisticated “high-frequency, low-latency” trading firms (a special type of investment firm) receive these wire services directly, and subject received press releases comprising text documents to the aforementioned high-speed automated processing pipeline, which may include:

(1) Authentication: Is a press release really from a wire service, and issued by a public company?

(2) Spam Deletion: Does the press release truly convey primary information about the public company mentioned, or is it just masquerading as such, trying to garner attention? (Small companies often discuss the products of much larger companies in their press releases for just this reason).

(3) Standardization: It is typically necessary to isolate and standardize trading symbols and trading exchanges of a public company. Since there are no universal standards, one wire service may print NYSE:BRK.B and another may print XNYS:BRK-B, referring to the same security (XNYS is the official ISO standard “ISO 10383 MIC Code” for the New York Stock Exchange a.k.a. NYSE, yet many press releases employ NYSE). Traders may employ a “symbology” (i.e., a “local standard”) that their trade execution software can recognize. As a result, what is contained in the press release may be converted to this “symbology.”

(4) Event Extraction: What corporate event is under discussion? A merger? A major personnel change? A lawsuit? A patent? A buyback? Etc. There are various systems for categorizing corporate events for which there may be 100 to 300 different event types. Event categorizations of words and phrases in a press release need to be analyzed quickly and most often by computer.

(5) Impact/Freshness/Relevance/Materiality Check: Is this the first announcement of an event, or a material change in the status of an on-going event? Conventionally, the answers to these questions may lead to trading opportunities. Routine announcements concerning the progress of a merger already underway, or a bankruptcy in process, generally have no impact on stock prices.

(6) Directionality/Sentiment Analysis: In combination with all the information extracted in the previous steps of the pipeline, can it be predicted with confidence whether, for the primary-traded stock of the company mentioned:

The stock will go up in price.

The stock will go down in price.

The traded volume of the stock will increase.

The traded volume of the stock will decrease.

The price volatility of the stock will increase.

The price volatility of the stock will decrease.

The bid-asked spread of the stock will increase.

The bid-asked spread of the stock will decrease.

This step, along with a numerical estimate of predicted changes in the above-cited factors, may be needed to place a trade, and is usually based on a complex word/phrase analysis to determine if news is “good” or “bad” for the underlying security, a measure known as “sentiment”.

Experienced human traders may be adept at viewing and comprehending a corporate press release on a computer screen, and may make a successful trade based on what they glean very quickly. Humans are capable of balancing and performing all six steps in the pipeline above substantially simultaneously. Traders may know hundreds of ticker symbols by heart, may keep very current on financial news to permit them to gauge freshness, and may have developed an instinctive understanding over many years of relevance, sentiment, and predicted directionality.

Human reaction time is typically 250 milliseconds, and the thought process described above may take about 750 milliseconds to perform. Stock trading records have shown that human traders commence trading about one second after the press release is made public (via a display). Therefore, even if each of the six steps in the processing pipeline took only 200 milliseconds to perform, humans would surpass conventional automated trading machines.

Therefore, a need exists in the art for a method for automated trading based on information in a press release that is significantly faster than human execution time.

### SUMMARY OF THE INVENTION

The above-described problems are addressed and a technical solution is achieved in the art by providing a computer implemented method and system for automated trading based on information in a press release. A programmed computer receives a press release from a wire service. The programmed computer scans each word of the press release sequentially. The programmed computer employs a scanned word as an index into a pre-processed table of reduced-encoded, negative sentiment and positive sentiment words, where sentiment is measured on a log-scale. The programmed computer fetches a word from the table based on the index. The programmed computer renders at least one trading decision based on the fetched word. The programmed computer delivers the at least one trading decision to at least one trading system.

Documents may be processed in parallel, and each document may be checked against conditions for multiple trading strategies that may be employed based on the document contents.

Multiple trading strategies may be determined to be applicable based on one pass through the document, rather than processing the document multiple times for each strategy. New methods for parsing the document without the use of indexing and hashing permit processing to be completed much more quickly than a human can process same.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 is a block diagram of one embodiment of a system for automated trading based on information in a press release;

FIG. 2 illustrates a diagrammatic representation of a machine in the exemplary form of a computer system within which a set of instructions, for causing the machine to perform any one or more of the methodologies discussed herein, may be executed;

FIG. 3 is a flow diagram illustrating one embodiment of a method for automated trading based on information in a press release; and

FIG. 4 illustrates encoding table for individual 7-character words, according to an embodiment of the present invention.

It is to be understood that the attached drawings are for purposes of illustrating the concepts of the invention and may not be to scale.

### DETAILED DESCRIPTION OF THE INVENTION

The present invention relates to a method for automated trading based on information in a press release. Documents may be processed in parallel, and each document may be checked against conditions for multiple trading strategies that may be employed based on the document contents.

Multiple trading strategies may be applicable based on one pass through a document, rather than processing the document multiple times for each strategy. New methods for parsing the document without the use of indexing and hashing permit the processing to complete much more quickly than by human traders or related art automated trading strategies.

One strategy for overcoming the deficiencies of the related art described above is to simplify a step; another is to apply faster algorithms to accomplish a step; and a third is to perform the steps in parallel.

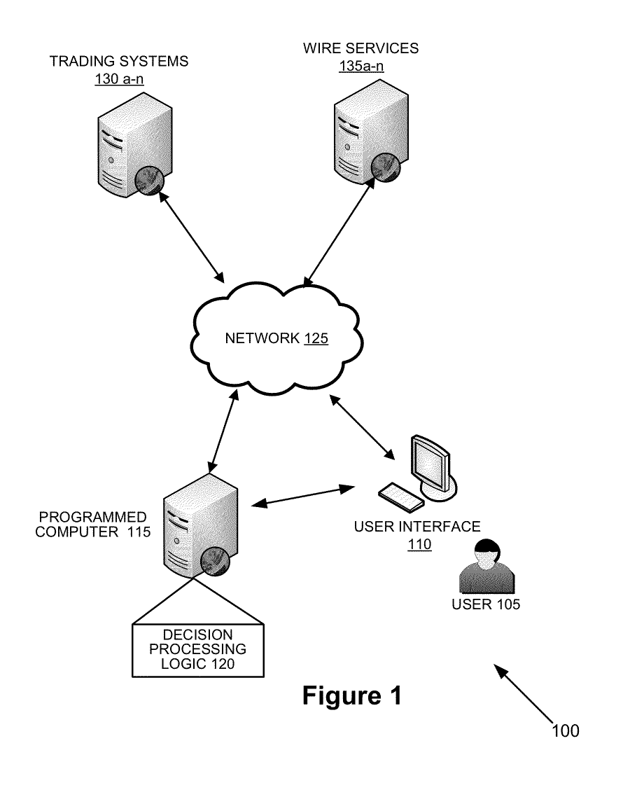

FIG. 1 is a block diagram of one embodiment of a system 100 for automated trading based on information in a press release. The system 100 is accessed by user 105 at a user interface device 110. The user interface device 110 accesses a programmed computer 115 hosting decision processing logic 120 for executing a method for automated trading based on information in a press release. The programmed computer 115 is communicatively connected with one or more trading systems 130a-130n over a network 125 to receive trading data and to transmit decisions on trades rendered by the decision processing logic 120. The programmed computer 115 is further communicatively connected with one or more wire services 135a-135n over the network 125 to receive press releases to be processed by the decision processing logic 120.

As used herein, the terms “program”, “application”, “software package” or “computer executable instructions” refer to instructions that may be performed by a computer processor and/or other suitable components. The term “computer”, “server”, “computing device”, as used herein, is not limited to any one particular type of hardware device, but may be any data processing device such as a desktop computer, a laptop computer, a kiosk terminal, a personal digital assistant (PDA), a tablet, a server, workstation, cluster of workstations, a distributed network of computers, a computing cloud, or any equivalents or combinations thereof. Any device or part of a device configured to process, manage or transmit data, whether implemented with electrical, magnetic, optical, biological components or otherwise, may be made suitable for implementing the invention described herein as would be appreciated by one of ordinary skill in the art having the benefit of this disclosure.

According to embodiments of the present invention, a computer may comprise storage media and/or be communicatively connected to a storage media. The term “storage media” can includes various storage media that can be used to store computer executable instructions. Storage media can include non-volatile media and/or volatile media, among other types of media and can be in the form of magnetic media, optical media, and/or physical media, among others. Some examples include hard disks, floppy disks, CD ROMs, DVDs, and Flash memory. Embodiments of the present invention are not limited to a particular type of storage media. One having ordinary skill in the art will appreciate that any number of computers and/or software modules may be utilized in implementing embodiment of the present invention.

The present invention may be implemented using a computer including memory resources coupled to a processor via a bus. The memory resource can include, but is not limited to, random access memory (RAM), read only memory (ROM), and/or other storage media capable of storing computer executable instructions, e.g., program instructions, that can be executed by the processor to perform various embodiments of the present invention. The memory resource instructions may store computer executable instructions either permanently or temporarily.

According to embodiments of the present invention, the one or more computers may be coupled to a display. The display can be a liquid crystal display (LCD) monitor or a cathode ray tube (CRT), or any other display type capable of displaying information to a user.

According to embodiments of the present invention, the one or more computers may be coupled to one or more input devices, including, but not limited to a keyboard, voice activated system, touch screen system, and/or mouse, among various other input devices.

According to embodiments of the present invention, the one or more computers include a communication interface configured to provide data communication coupling between the one or more computers and any communicatively connected components, such as the network 125, other computing devices, e.g., client and/or server devices, storage media, and the like. As used herein, the term communicatively connected is intended to include any type of connection, whether wired or wireless, in which data may be communicated. Furthermore, the term “communicatively connected” is intended to include a connection between devices and/or programs within a single computer or between devices and/or programs on separate computers. As a non-limiting example, the communication interface can be an integrated services digital network (ISDN) card or a modem used to provide a data communication connection to a corresponding type of telephone, cable, wireless, or fiber line. The communication interface can also be a LAN card used to provide a data communication connection to a compatible LAN. The interface can also be a wireless link used to send and receive various types of information.

Although specific embodiments have been illustrated and described herein, those of ordinary skill in the art will appreciate that an arrangement configured to achieve the same results may be substituted for the specific embodiments shown. This disclosure is intended to cover adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes other applications in which the above structures and methods are used.

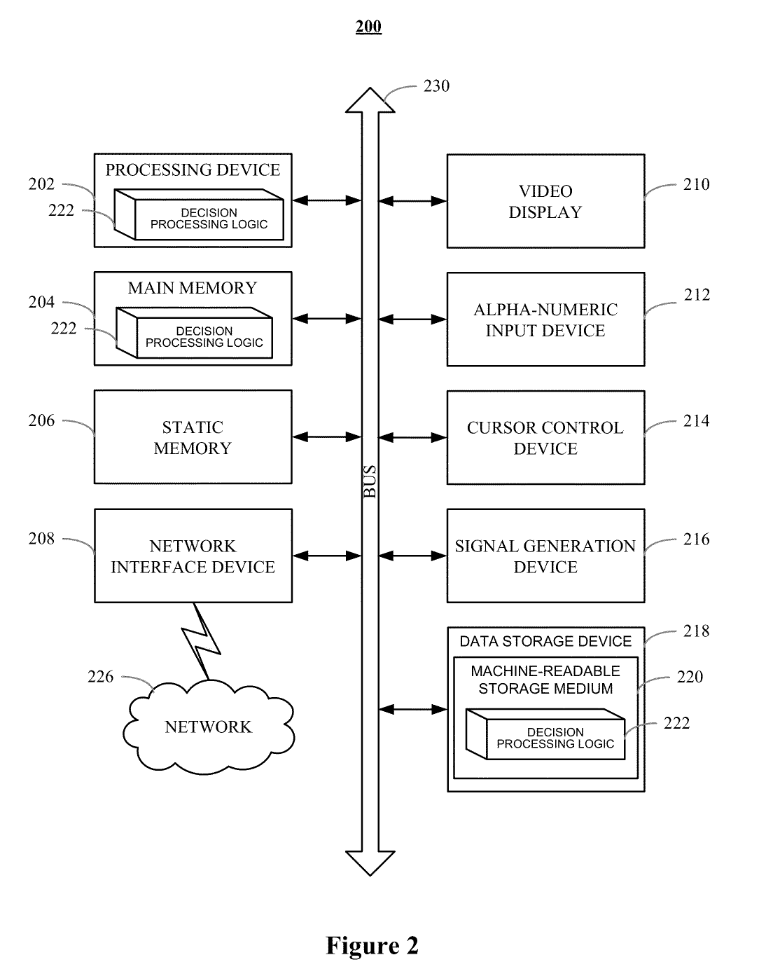

FIG. 2 illustrates a diagrammatic representation of a machine in the exemplary form of a computer system 200 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment (i.e., programmed computer 115), or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 200 includes a processing device 202, a main memory 204 (e.g., read-only memory (ROM), flash memory, dynamic random access memory (DRAM) (such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 230.

Processing device 202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 202 may also be one or more special-purpose processing devices such as an application specific integrated circuit (ASIC), a field programmable gate array (FPGA), a digital signal processor (DSP), network processor, or the like. Processing device 202 is configured to execute device queue manager logic 222 for performing the operations and steps discussed herein.

Computer system 200 may further include a network interface device 208. Computer system 200 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

Data storage device 218 may include a machine-readable storage medium (or more specifically a computer-readable storage medium) 220 having one or more sets of instructions (e.g., decision processing logic 222) embodying any one or more of the methodologies of functions described herein. Decision processing logic 222 may also reside, completely or at least partially, within main memory 204 and/or within processing device 202 during execution thereof by computer system 200; main memory 204 and processing device 202 also constituting machine-readable storage media. Decision processing logic 222 may further be transmitted or received over a network 226 via network interface device 208.

Machine-readable storage medium 220 may also be used to store the device queue manager logic persistently. While machine-readable storage medium 220 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein may be implemented as discrete hardware components or integrated in the functionality of hardware components such as ASICs, FPGAs, DSPs or similar devices. In addition, these components may be implemented as firmware or functional circuitry within hardware devices. Further, these components may be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

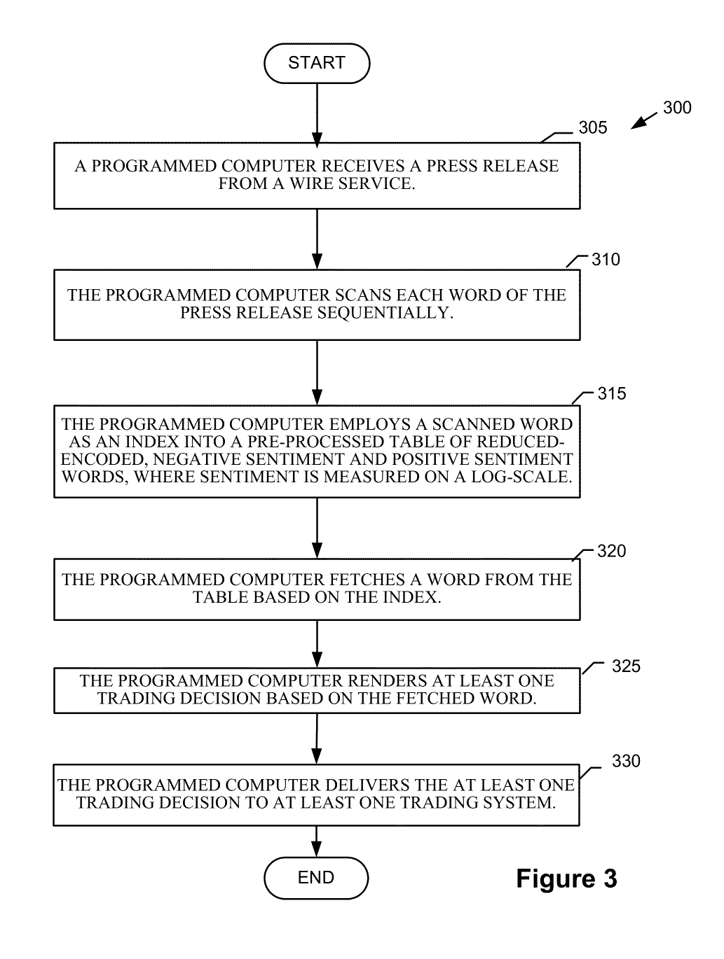

One or more embodiments of the present invention are based on a principle that a combination of two less-inclusive newsfeeds, neither of which would be selected in a search query on its own, may out-perform a more comprehensive newsfeed. The two less-comprehensive newsfeeds, taken together, may yield a more non-duplicative news story for less expenditure than the more comprehensive newsfeed as illustrated in the method of FIG. 3.

FIG. 3 is a flow diagram illustrating one embodiment of a method 300 for automated trading based on information in a press release. At block 305, the programmed computer 115 receives a press release from a wire service (e.g., 135a). At block 310, the programmed computer 115 scans each word of the press release sequentially. At block 315, the programmed computer 115 employs a scanned word as an index into a pre-processed table of reduced-encoded, negative sentiment and positive sentiment words, where sentiment is measured on a log-scale. At block 320, the programmed computer 115 fetches a word from the table based on the index. At block 325, the programmed computer 315 renders at least one trading decision based on the fetched word. At block 330, the programmed computer 315 delivers the at least one trading decision to at least one trading system (e.g., 130a).

### Log Scaling and Boolean Evaluation

Related art relevance and sentiment scores are usually expressed on a 10 point scale, e.g., 0 to 10. The higher the scores, the more likely an automated trading algorithm may recommend a trade. Often a threshold is established (e.g., if the score is above 8.5, trade). Scores are computed from weights on individual words, phrases, or metadata in a press release. Words and weights are determined using a categorization algorithm, for instance, boolean rules, decision trees, neural networks, support vector machines, etc.

In one embodiment, if, the logarithm base 10 of a score is considered, the following three key numeric points may be obtained:

Log(0)=negative infinity

### Log(1)=0

### Log(10)=1

This leads to considering many words as neutral (0), some words as positive (1), and some words as totally negative (negative infinity). If, in one embodiment, a NOT/PLUS threshold is set to Log(10)=1 (i.e., >=1 set to PLUS, and <1 set to NOT), then computing the scores may be simplified to: (1) process a list of NOT words/phrases (i.e., do not trade if any of these words/phrases appear in the press release (headline or body)) and (2) process a list of PLUS words/phrases (i.e., consider trading (as long as trading is not ruled out by (1) above) if one or more (ANY) of the words/phrases in this list appear in the press release (headline or body)).

In certain embodiments, various types of press releases and corporate events may call for scanning only the headline, only the body, or both.

In one embodiment, this type of processing press releases may proceed by scanning the NOT and scanning the PLUS list separately. Conventional theories exist for which to scan first in an attempt to short-circuit the evaluation by stopping when a NOT word/phrase is matched, and/or stopping the PLUS list processing when a PLUS word/phrase is matched. These theories employ the expected frequencies of the words/phrases, often estimated using a corpus of past press releases.

In one embodiment, the method may scan words of a press release sequentially while consulting a pre-processed table of NOT and PLUS words.

### Wire-Speed 5-Bit Shift, Base-32 Encoding, and 35-Bit Addressing

Today's computer systems generally encode text with 8-bit encoding (or 16-bit encoding if non-English is used). 8-bit encoding permits 256 different characters (upper and lower case letters, digits, punctuation marks, graphic characters, control characters, and accented characters). This works well with modern 32-bit computers, which use 8-bit bytes and 16-bit or 32-bit words. Addressing is usually 32-bit, which permits 4 GB of memory to be addressed (which is typically less than the amount of physical memory installed on larger servers), or 64-bit, which permits huge flat address spaces (far in excess of the physical memory installed).

In past decades, 6-bit, or “sixel” encoding was employed. This permitted encoding of 64 different characters, enough for upper and lower case letters, 10 digits, space, and period—not quite enough for English text, but good enough for a close approximation to it, especially if the focus was only on individual words and phrases, as opposed to document structure as a whole. This fit well with 36-bit computers that were then in use. The algorithms developed are still in use today in Base-64 encoding of binary files.

Certain embodiments of the present invention may reduce 6-bit encoding further. In one embodiment, encoding is based on fewer than 6-bits (e.g., only 32 characters may be encoded—a 5-bit encoding). Letters may be encoded without regard to case, the digits 1 to 4 as used in financial quarters, a generic digit # for any other digit, and a generic internal punctuation mark (e.g., the “@” sign and dot as used in email addresses, urls, etc). These 32 characters do not include any word separators or sentence/partial sentence separators—the text cannot be reconstructed from the parsed encoding, but words can be delimited as the parsing proceeds, and as well as sentence/partial sentence endings (semi-colon, non-interior periods, etc.).

In one embodiment, words may be truncated to 7 characters. Analysis has shown that for the purposes of financial event filtering, there is no effective loss in signal. With 5 bits used for each character, words may be encoded in 5×7=35 bits. Since a “gigabyte” (more correctly, gibibyte) of RAM is 2̂30 bytes, 35=30+5, and 2̂5=32, it follows that, with this method of encoding and truncation, every word in the language can be directly addressed in a table that fits in 32 gigabytes of RAM if a byte for each word is selected to be stored, or 64 gigabytes (64 GB, more correctly, 64 GiB) of RAM if a 16-bit value for each word is selected to be stored.

A 16-bit value permits a 65,536-way branch when a word is encountered, sufficient to encode complex finite-state machines to (a) assemble multi-word phrases, (b) detect ends of sentences and partial sentences, and (c) detect the presence of NOT and PLUS words/phrases across many multiple NOT and PLUS lists. An effective implementation of this method of branching is to build a matrix structure that is 64K deep and (for example) 64K bytes wide, which occupies another 4 GiB. The 16-bit value stored for each word in the 64 GiB table directly addresses the row of this 4 GiB table.

Modern servers may include 96 or 128 GiB of RAM, leaving plenty of room for computation and other data storage after the 64+4 GiB of storage is allocated as above.

35-bit addressing and 5-bit encoding are not typical, but they can be efficiently implemented on 32-bit, 8-bit-encoding modern computers. As each 8-bit character of a press release is received from a wire, it is “looked up” in a table of size 256 (1 byte wide). The byte so fetched (i.e., in a single operation with no hash or test needed) is either the 32-base encoded value (a number from 0 to 31) of the character (for example, “a”, “A”, and every accented version of “a” might map to the value 1), or, if the value is between 32 and 255 (255 being the maximum value of a byte), a signal to skip the char, close off the current word, and similar housekeeping operations triggered on punctuation, etc. For example, the apostrophe may be action 90, which translates to dropping this character, but setting a special flag. The character “s” may map to 100, which means “if the apostrophe flag is set, skip this char, but otherwise encode it with the correct value for the character's' ”. The end of word action would clear the apostrophe flag.

As each valid encoding from 0 to 31 is output from this operation, the correct 5 bits are pushed leftward into a 64-bit “quad” word that begins at all zeros. When 7 pushes have been made, or the end-of-word action triggered, a 35-bit address is located in the 64-bit word that can be used to directly address the main table (shift one bit to double its value and add as an integer to the base address of the table).

Thus, at “wire speed”, each inbound character is encoded and used to build the encoding of each word, and each word directly triggers an action, pre-stored to determine if a NOT, PLUS, or word-in-a-phrase condition has been encountered.

There are no hash function calculations and no string scanning involved. There is no need to compute or store the frequencies of each NOT or PLUS word/phrase.

As has been shown, the 5-bit-encoding/35-bit addressing method can be efficiently implemented on standard 16/32/64 bit computers. Certain embodiments of the present invention may instead employ special-purpose hardware constructed around 5-bit shifts to efficiently implement the 5-bit-encoding/35-bit addressing method.

### Parallel Lookup

As described above, there are many types of corporate events that can be disclosed in a press release, and each has its own pattern of use and words/phrases to trigger trading opportunities. Moreover, checks on freshness, relevance, etc., may need to proceed differently for each type of event.

In an embodiment, with the wire-speed processing (letter-by-letter, word-by-word) discussed above, up to and including all 6 steps in a pipeline, all possible events and trading strategies, may be processed in parallel, including the aforementioned 5-bit-encoding/35-bit addressing method, with a single pass through the press release that occurs automatically as the press release flows in from the wire service.

For example, suppose Trading Strategy 3 involves mergers and acquisitions, and Trading Strategy 9 involves upgrades. Then, when the word “analyst” is encountered (note this is 7 letters, enough to distinguish it from “analysis” and “analyzing”, for example), it is PLUS for detecting a possible upgrade, and NOT for mergers (i.e., since an analyst comment in a merger story indicates lack-of-freshness, i.e., this is not the initial announcement of the merger).

In one embodiment of an encoding, this may appear as follows:

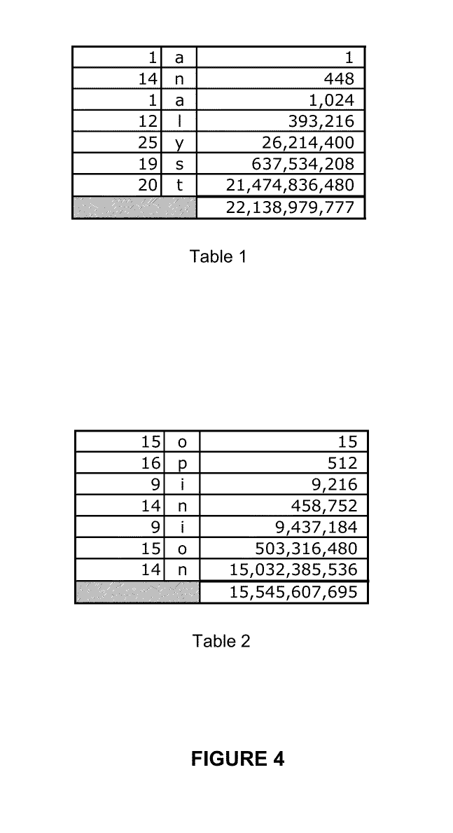

a=1
n=14 . . . and so on, leading to the following (based on multiplying by powers of 32) (See Table 1 of FIG. 4). Then at position 22,138,979,777 of the master word table, a pointer may indicate 23,455. Position 23,455 of the branching action table may indicate:

### {3: NOT; 9: PLUS}

This would lead to setting a NO flag in slot 3 of a strategy table, and setting the PLUS count to YES, or adding one to the PLUS count as appropriate, in slot 9 (unless there were already a NO set in slot 9).

The same processing would result for “Analyst” or “analyst's” or “analysts'”.

If it were decided instead that only the phrase “Analyst Opinion” (or several variations thereof) were PLUS for Strategy 9, then the action would not have 9:PLUS but rather an operand such as (See Table 2 of FIG. 4):

### SET ANTECENDANT 15545607695 TO 14

This assumes “Analyst” was the 14^{th} word encountered, and 15545607695 was the encoding for “opinion” (see table below), which was performed off-line, in advance of news processing.

If and when “opinion” was encountered, if it were the 15^{th} word, then a PLUS directive would fire. If a different strategy depended on the phrase “Executive Opinion”, then similar directives would result in the slot pointed to by the table position for the term “executi”, the 7-truncation of “executive”. There would be no confusing of “Analyst Opinion” and “Executive Opinion”, only one of which can be a correct conclusion when “opinion” is encountered.

This approach extends easily to multi-word (3, 4, 5, etc., word phrases), simply by having an action triggered by an ANTECEDANT match simply set another ANTECENDANT for another word (the next word needed to match the phrase).

While the pre-processing for providing all the rules for all the words/phrases in all the strategies is substantial, this pre-processing is performed off-line. Once press releases begin to flow into the system at wire speed, certain embodiments process multiple strategies substantially simultaneously and optimally, with no multi-character string matching and no hashing. Processing of a press release stops immediately once there are no more rules that can be possibly matched (a running total of NO flags is maintained, and the total number of strategies known).

The master table may be employed to point to standardized values of exchanges and tickers, along with the character action table, so that XNYS:IBM can be turned into Exchange=NYSE and Symbol=IBM. This all occurs in the same, once-and-only-once, scan of all characters as they flow in on the wire.

In one embodiment, all six pipeline steps are handled simultaneously, as are all trading rules in Step 4.

Since, in one embodiment, the large master data table is read-only, multiple press releases can be processed simultaneously if multiple cores are available. Each would have its own 4 GiB action table (which could be made smaller by making each of the 64K rows have fewer than 64K bytes of storage) and its own strategy tables, since these are updated dynamically (the action table is updated dynamically to handle phrases).

In one embodiment, the master table may be stored in non-volatile Flash memory so that loading to core memory on machine-boot may be performed in reasonable time. Since stocks are traded only during defined hours (even taking “after-hours” trading in to account), there is no problem in loading this table in a scheduled, planned manner.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but may be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A computer-implemented method for automated trading based on information in a press release, comprising the steps of:
receiving, using a programmed computer, a press release from a wire service;
scanning each word of the press release sequentially;
employing a scanned word as an index into a pre-processed table of reduced-encoded, negative sentiment and positive sentiment words, wherein sentiment is measured on a log-scale;
fetching a word from the table based on the index;
rendering at least one trading decision based on the fetched word; and
delivering the at least one trading decision to at least one trading system.
